(19) United States
(12) Patent Application Publication
(10) Pub. No.: US 2026/0200423 A1
(43) Pub. Date: Jul. 16, 2026

(54) COUPLING STRUCTURE

(71) Applicant: SUBARU CORPORATION, Tokyo (JP)

(72) Inventor: Keita INAMURA, Tokyo (JP)

(73) Assignee: SUBARU CORPORATION, Tokyo (JP)

(21) Appl. No.: 19/444,450

(22) Filed: Jan. 9, 2026

(30) Foreign Application Priority Data
Jan. 15, 2025 (JP) 2025-005818

(51) Int. Cl. B60R 19/34; B60Q 1/04; B60Q 1/20

(52) U.S. Cl. CPC B60R 19/34; B60Q 1/0408; B60Q 1/20

(57) ABSTRACT

A coupling structure couples a vehicle component disposed at a front portion of a vehicle to a structural member disposed adjacently to the vehicle component in a vehicle width direction. The coupling structure includes first and second brackets, a pressing member, and a coupling member. The first bracket is coupled to the vehicle component and extends from the vehicle component toward the structural member. The second bracket is attached to the structural member and includes an extending portion extending from the structural member toward the vehicle component. The pressing member is disposed forward of the first bracket. The coupling member couples the pressing member, the first bracket, and the extending portion to sandwich the first bracket between the pressing member and the extending portion. When a rearward force acts on the vehicle component, the pressing member presses a fragile portion of the first bracket.

### CROSS-REFERENCE TO RELATED APPLICATIONS

The present application claims priority from Japanese Patent Application No. 2025-005818 filed on January 15, 2025, the entire contents of which are hereby incorporated by reference.

### BACKGROUND OF THE INVENTION

### FIELD OF THE INVENTION

The disclosure relates to a coupling structure.

### Description of Background Art

Japanese Unexamined Patent Application Publication (JP-A) No. 2013-75559, for example, describes a technique of fastening a vehicle component. The entire contents of this publication are incorporated herein by reference.

### SUMMARY OF THE INVENTION

According to one aspect of the present invention, a coupling structure for a vehicle includes a first bracket coupled to a vehicle component positioned at a front portion of a vehicle and extending from the vehicle component toward a structural member positioned adjacently to the vehicle component in a vehicle width direction, a second bracket attached to the structural member and including an extending portion that extends from the structural member toward the vehicle component in the vehicle width direction, a pressing member that is positioned forward of the first bracket in a longitudinal direction of the vehicle and presses a fragile portion of the first bracket when a rearward force in the longitudinal direction of the vehicle acts on the vehicle component, and a coupling member that couples the pressing member, the first bracket, and the extending portion of the second bracket such that the first bracket is sandwiched between the pressing member and the extending portion of the second bracket.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating a schematic configuration of a vehicle according to an embodiment of the disclosure;

FIG. 2 is a front view of a coupling structure according to the embodiment;

FIG. 3 is a plan view of the coupling structure according to the embodiment;

FIG. 4 is a partial enlarged view of FIG. 3;

FIG. 5 is a diagram illustrating another example of the coupling structure according to the embodiment;

FIG. 6 is a diagram illustrating operations of a first bracket and a second bracket according to a comparative example; and

FIG. 7 is a diagram illustrating an operation of the coupling structure according to the embodiment.

### DETAILED DESCRIPTION OF THE EMBODIMENTS

Embodiments will now be described with reference to the accompanying drawings, wherein like reference numerals designate corresponding or identical elements throughout the various drawings.

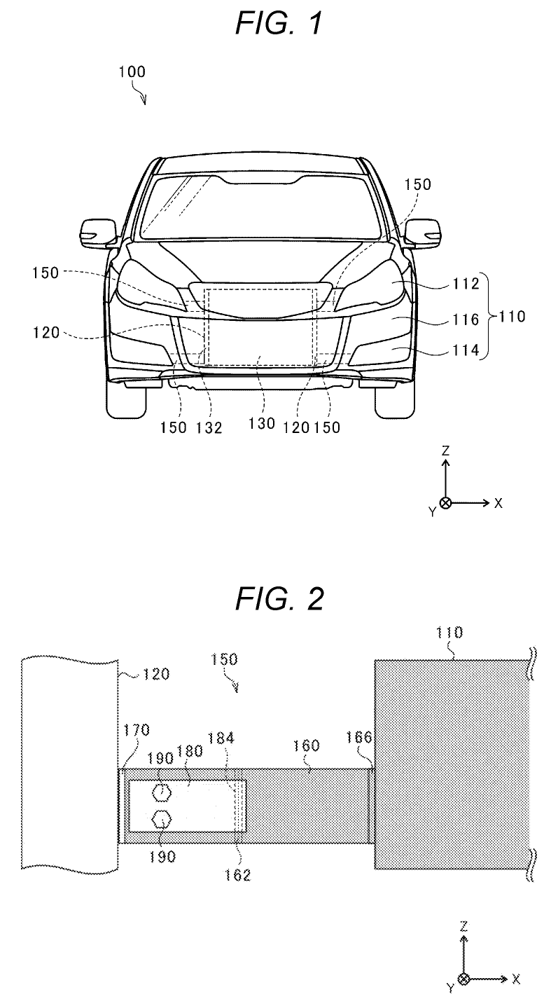

First, a configuration of a vehicle 100 according to an embodiment of the disclosure will be described with reference to FIG. 1. FIG. 1 is a schematic diagram illustrating a schematic configuration of the vehicle 100 according to the embodiment of the disclosure. As illustrated in FIG. 1, the vehicle 100 includes a vehicle component 110. The vehicle component 110 is provided at a front portion of the vehicle 100. The vehicle component 110 is, for example, a headlamp 112, a fog lamp 114, or a front bumper 116.

The vehicle component 110 is coupled to a structural member 120 disposed adjacently to the vehicle component 110 in a vehicle width direction (±X direction in FIG. 1) by a coupling structure 150. When the vehicle component 110 is the headlamp 112 or the fog lamp 114, the structural member 120 is, for example, a side panel 132 provided on a side surface of a radiator 130. When the vehicle component 110 is the front bumper 116, the structural member 120 is, for example, a wheel apron.

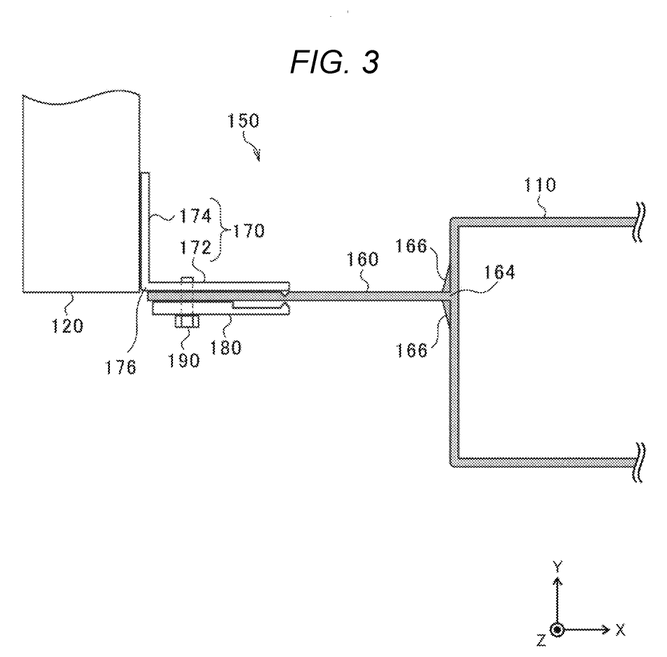

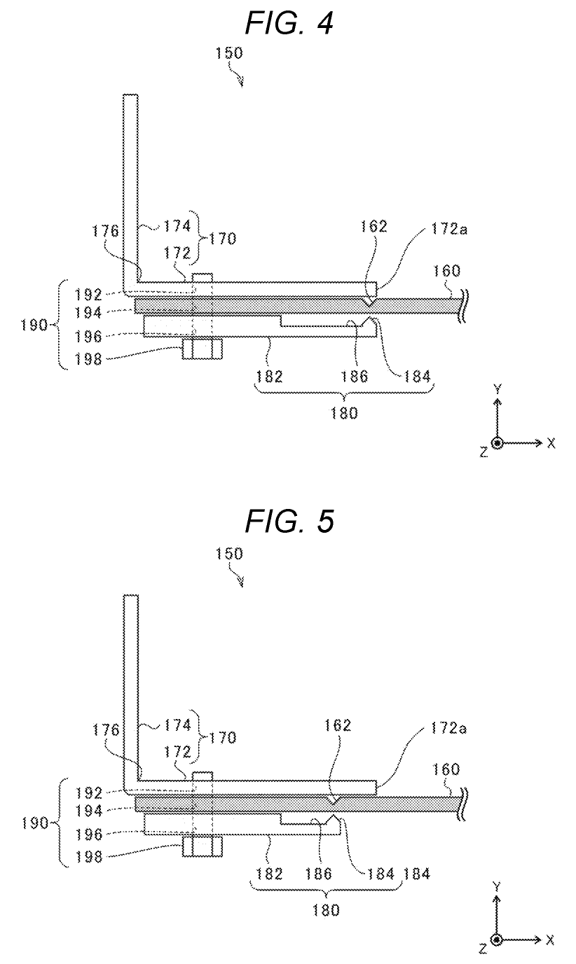

Next, a configuration of the coupling structure 150 according to the present embodiment will be described with reference to FIGS. 2 to 4. FIG. 2 is a front view of the coupling structure 150 according to the present embodiment. FIG. 3 is a plan view of the coupling structure 150 according to the present embodiment. FIG. 4 is a partial enlarged view of FIG. 3.

As illustrated in FIGS. 2 to 4, the coupling structure 150 includes a first bracket 160, a second bracket 170, a pressing member 180, and coupling members 190.

The first bracket 160 is a member that is coupled to the vehicle component 110 and extends from the vehicle component 110 toward the structural member 120 in the vehicle width direction (-X direction in FIGS. 2 to 4). The first bracket 160 is, for example, a rectangular plate. The first bracket 160 is made of, for example, resin. The first bracket 160 is, for example, permanently affixed to the vehicle component 110 as a whole.

A rib 166 is provided at a coupling portion 164 where the vehicle component 110 is coupled to the first bracket 160. The rib 166 reinforces the coupling portion 164. Since the rib 166 is provided at the coupling portion 164, a strength of the coupling portion 164 can be improved.

As illustrated in FIGS. 2 and 4, a fragile portion 162 is provided on a part of the first bracket 160. The fragile portion 162 is provided on, for example, a rear side (+Y side in FIGS. 2 to 4) of the first bracket 160 in a longitudinal direction (-Y direction in FIGS. 2 to 4) of the vehicle 100. The fragile portion 162 is a portion of the first bracket 160 having a lower rigidity than those of other portions. The fragile portion 162 is, for example, a groove, a recess, a through hole, or a notch. The fragile portion 162 is, for example, a belt-shaped groove extending in up and down directions (±Z directions in FIGS. 2 to 4).

The second bracket 170 is attached to the structural member 120. The second bracket 170 is made of, for example, metal.

The second bracket 170 includes an extending portion 172. The extending portion 172 extends from the structural member 120 toward the vehicle component 110 in the vehicle width direction (+X direction in FIGS. 2 to 4).

As illustrated in FIG. 3, the second bracket 170 may further include an attachment portion 174 attached to the structural member 120. The attachment portion 174 is, for example, attached to the structural member 120 by welding. As illustrated in FIG. 3, in the present embodiment, the second bracket 170 has a structure in which the extending portion 172 is bent with respect to the attachment portion 174. For example, the second bracket 170 has a structure in which the attachment portion 174 is bent rear ward (+Y side in FIGS. 2 to 4) in the longitudinal direction (-Y direction in FIGS. 2 to 4) of the vehicle 100 with respect to the extending portion 172.

The pressing member 180 is disposed forward of the first bracket 160 in the longitudinal direction (-Y side in FIGS. 2 to 4) of the vehicle 100. The pressing member 180 is made of, for example, metal. The pressing member 180 includes, for example, a rectangular plate.

As illustrated in FIG. 4, the pressing member 180 may include a base 182, a protrusion 184, and a recess 186. The base 182 is a flat base portion for attaching the pressing member 180 to the first bracket 160 and the second bracket 170. The base 182 is coupled to the first bracket 160 and the extending portion 172 of the second bracket 170.

The protrusion 184 protrudes from a tip of the pressing member 180 and is disposed at a position facing the fragile portion 162 of the first bracket 160. The protrusion 184 may be a protruding strip portion protruding rearward (+Y direction in FIGS. 2 to 4) in the longitudinal direction (-Y direction in FIGS. 2 to 4) of the vehicle 100 and extending in the up and down directions (±Z directions in FIGS. 2 to 4). The protrusion 184 extending in the up and down direction faces the fragile portion 162 extending in the up and down directions. In some embodiments, a horizontal cross- sectional shape of the protrusion 184 is a sharply pointed shape, such as triangular. Alternatively, the horizontal cross-sectional shape may be rectangular, semi-circular, or semi-elliptic. The protrusion 184 does not come into contact with the first bracket 160 in a normal state in which no rearward force in the longitudinal direction of the vehicle 100 acts on the vehicle component 110.

The recess 186 has a recessed structure provided between the base 182 and the protrusion 184 of the pressing member 180. The recess 186 is recessed forward (-Y direction in FIGS. 2 to 4) in the longitudinal direction of the vehicle 100 as compared with the base 182 and the protrusion 184. The recess 186 does not come into contact with the first bracket 160. By providing the recess 186 and the protrusion 184 on a tip side of the pressing member 180, the tip side of the pressing member 180 has a hook-shaped structure that floats from the first bracket 160. Since the pressing member 180 includes the protrusion 184 and the recess 186, when the first bracket 160 is curved as will be described later, the protrusion 184 can be first locally brought into contact with the fragile portion 162 of the first bracket 160.

The coupling members 190 couple the pressing member 180, the first bracket 160, and the extending portion 172 of the second bracket 170 to sandwich the first bracket 160 between the pressing member 180 and the extending portion 172 of the second bracket 170. The coupling member 190 has, for example, a fastening structure. The coupling member 190 includes, for example, a screw groove 192, through holes 194 and 196, and a male screw portion 198. The screw groove 192 is provided in the extending portion 172 of the second bracket 170. The through hole 194 is provided in the first bracket 160. The through hole 194 is provided, for example, between a tip portion (end on a structural member 120 side) of the first bracket 160 and the fragile portion 162. The through hole 196 is provided in the base 182 of the pressing member 180. Hole diameters of the through holes 194 and 196 are slightly larger than an outer diameter of a shaft portion of the male screw portion 198.

To describe coupling by the coupling member 190, first, the second bracket 170, the first bracket 160, and the pressing member 180 are disposed in this order such that the through hole 194 of the first bracket 160 and the through hole 196 of the base 182 of the pressing member 180 correspond to the screw groove 192 of the extending portion 172 of the second bracket 170. The male screw portion 198 is inserted into the through hole 196 of the pressing member 180 and the through hole 194 of the first bracket 160. The shaft portion of the male screw portion 198 is not screwed into the through hole 196 and the through hole 194, and the outer diameter of the shaft portion of the male screw portion 198 is smaller than the hole diameters of the through holes 194 and 196. Therefore, the male screw portion 198 is rotatable in the through holes 194 and 196. On the other hand, a tip side of the shaft portion of the male screw portion 198 is screwed into the screw groove 192 of the second bracket 170. Therefore, as the male screw portion 198 is screwed deeper into the screw groove 192, a head of the male screw portion 198 can be moved rearward (+Y direction in FIGS. 2 to 4) in the longitudinal direction (-Y direction in FIGS. 2 to 4) of the vehicle 100. The male screw portion 198 is screwed into the screw groove 192 until the pressing member 180 is locked by the head of the male screw portion 198. Accordingly, the first bracket 160 and the pressing member 180 are fixed to the extending portion 172 of the second bracket 170 by the male screw portion 198.

The coupling member 190 is not limited to the example of the fastening structure described above as long as the coupling member 190 can couple the pressing member 180, the first bracket 160, and the extending portion 172 of the second bracket 170 with the first bracket 160 sandwiched between the pressing member 180 and the extending portion 172 of the second bracket 170. The coupling member 190 may be, for example, a rivet.

Next, a positional relationship among the fragile portion 162 of the first bracket 160, the protrusion 184 of the pressing member 180, and the extending portion 172 of the second bracket 170 will be described with reference to FIGS. 4 and 5. FIG. 5 is a diagram illustrating another example of the coupling structure 150 according to the present embodiment.

As illustrated in FIG. 4, in some embodiments, the fragile portion 162 of the first bracket 160 is provided at a position where the fragile portion 162 is to be held between the protrusion 184 provided on the tip of the pressing member 180 and a tip 172a of the extending portion 172 of the second bracket 170.

As illustrated in FIG. 5, the fragile portion 162 of the first bracket 160 may not be provided at a position facing the tip 172a of the extending portion 172 of the second bracket 170. For example, the fragile portion 162 of the first bracket 160 may be provided at a position facing the extending portion 172 of the second bracket 170. The fragile portion 162 of the first bracket 160 may be provided at a position in the second bracket 170 that faces a position between the tip 172a of the extending portion 172 and a bent portion 176 between the extending portion 172 and the attachment portion 174. The fragile portion 162 of the first bracket 160 may be provided at a position facing the extending portion 172 of the second bracket 170 and in the vicinity of the tip 172a of the extending portion 172.

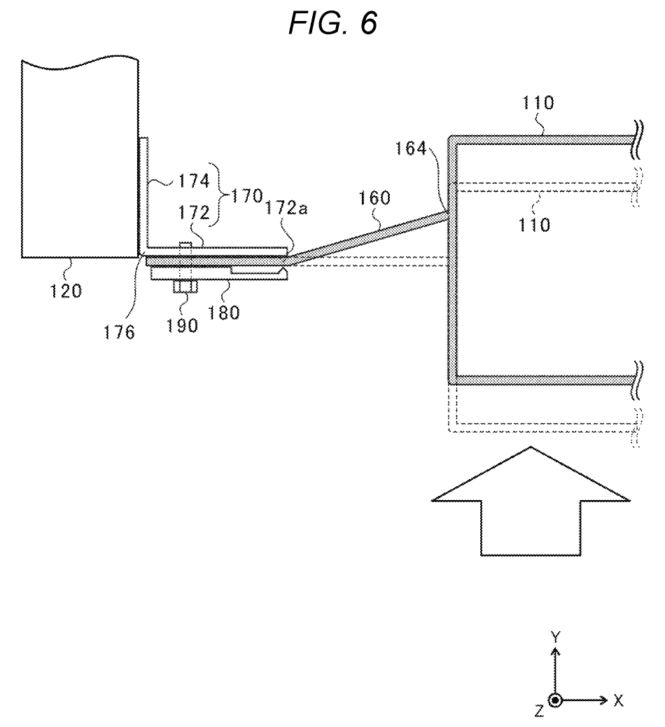

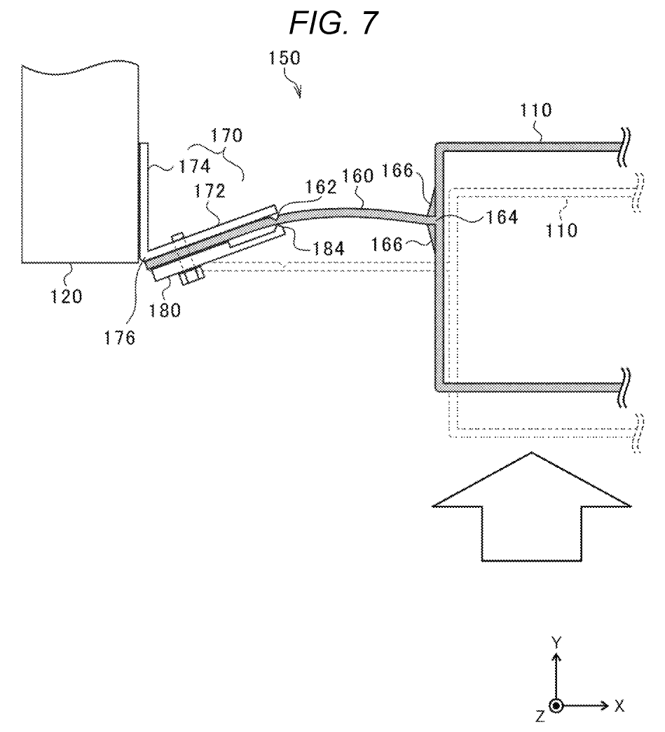

Next, an operation of the coupling structure 150 according to the present embodiment will be described with reference to FIGS. 6 and 7. FIG. 6 is a diagram illustrating operations of the first bracket 160 and the second bracket 170 according to a comparative example. FIG. 7 is a diagram illustrating an operation of the coupling structure 150 according to the present embodiment.

As illustrated in FIG. 6, in the comparative example, the rib 166 is not provided at the coupling portion 164 where the vehicle component 110 is coupled to the first bracket 160. In the comparative example, a strength of the bent portion 176 between the attachment portion 174 and the extending portion 172 of the second bracket 170 is larger than that of the coupling portion 164 between the first bracket 160 and the vehicle component 110.

In the comparative example, when a rearward force (white arrow pointing in +Y direction in FIG. 6) in the longitudinal direction of the vehicle 100 acts on the vehicle component 110 due to a collision of the vehicle 100, the force is transmitted to the first bracket 160. As described above, in the comparative example, the strength of the bent portion 176 between the attachment portion 174 and the extending portion 172 of the second bracket 170 is larger than that of the coupling portion 164 between the first bracket 160 and the vehicle component 110. Therefore, due to the force transmitted to the first bracket 160, the first bracket 160 is first curved to be convex forward (-Y direction in FIG. 6) in the longitudinal direction of the vehicle 100 starting from the tip 172a of the extending portion 172 of the second bracket 170.

Then, the protrusion 184 of the pressing member 180 does not abut on the fragile portion 162 of the first bracket 160, and the fragile portion 162 of the first bracket 160 is not pressed by the pressing member 180. Therefore, in the comparative example, the fragile portion 162 of the first bracket 160 may not be bent at an early stage.

Therefore, in some embodiments, the strength of the bent portion 176 between the attachment portion 174 and the extending portion 172 of the second bracket 170 is smaller than that of the coupling portion 164 between the first bracket 160 and the vehicle component 110.

As illustrated in FIG. 7, the pressing member 180 according to the present embodiment presses the fragile portion 162 provided on a part of the first bracket 160 when a rearward force (white arrow pointing in +Y direction in FIG. 7) in the longitudinal direction of the vehicle 100 acts on the vehicle component 110.

For example, consider a case where due to the collision of the traveling vehicle 100 with an object ahead of the vehicle 100, a rearward impact force (white arrow pointing in +Y direction in FIG. 7) in the longitudinal direction of the vehicle 100 acts on the vehicle component 110 disposed at the front portion of the vehicle 100. In this case, it is desirable that in a state in which the first bracket 160 is sandwiched between the extending portion 172 of the second bracket 170 and the pressing member 180, the first bracket 160 is curved, and the fragile portion 162 of the curved first bracket 160 is locally pressed by the protrusion 184 of the pressing member 180.

As illustrated in FIG. 7, when the rearward force (white arrow pointing in +Y direction in FIG. 7) in the longitudinal direction of the vehicle 100 acts on the vehicle component 110 due to the collision of the vehicle 100, the force is transmitted to the extending portion 172 of the second bracket 170 via the first bracket 160. As described above, the strength of the bent portion 176 between the attachment portion 174 and the extending portion 172 of the second bracket 170 is smaller than that of the coupling portion 164 between the first bracket 160 and the vehicle component 110. Therefore, the force transmitted to the extending portion 172 of the second bracket 170 first deforms the extending portion 172 of the second bracket 170 such that the extending portion 172 of the second bracket 170 is bent rearward (+Y direction in FIG. 7) in the longitudinal direction of the vehicle 100. For example, the extending portion 172 of the second bracket 170 is deformed such that an angle between the extending portion 172 and the attachment portion 174 of the second bracket 170 becomes smaller.

Next, the first bracket 160 is curved to be convex rearward (+Y direction in FIG. 7) in the longitudinal direction of the vehicle 100. As described above, the fragile portion 162 of the first bracket 160 is to be held between the protrusion 184 provided on the tip of the pressing member 180 and the tip 172a of the extending portion 172 of the second bracket 170. Therefore, when the first bracket 160 is curved, the protrusion 184 of the pressing member 180 abuts on the fragile portion 162 of the first bracket 160, and the protrusion 184 of the pressing member 180 locally presses the fragile portion 162 of the first bracket 160. As a result, the fragile portion 162 of the first bracket 160 is broken to relieve the impact force acting on the collide object from the vehicle component 110.

Next, effects of the coupling structure 150 according to the embodiment of the disclosure will be described.

The coupling structure 150 according to the present embodiment is for coupling the vehicle component 110 disposed at the front portion of the vehicle 100 to the structural member 120 disposed adjacently to the vehicle component 110 in the vehicle width direction. The coupling structure 150 includes the first bracket 160, the second bracket 170, the pressing member 180, and the coupling member 190. The first bracket 160 is coupled to the vehicle component 110 and extends from the vehicle component 110 toward the structural member 120 in the vehicle width direction. The second bracket 170 is attached to the structural member 120 and includes the extending portion 172 that extends from the structural member 120 toward the vehicle component 110 in the vehicle width direction. The pressing member 180 is disposed forward of the first bracket 160 in the longitudinal direction of the vehicle 100. The coupling member 190 couples the pressing member 180, the first bracket 160, and the extending portion 172 of the second bracket 170 to sandwich the first bracket 160 between the pressing member 180 and the extending portion 172 of the second bracket 170. When the rearward force in the longitudinal direction of the vehicle 100 acts on the vehicle component 110, the pressing member 180 presses the fragile portion 162 provided on a part of the first bracket 160.

When the pressing member 180 is not provided, and when the rearward impact force in the longitudinal direction of the vehicle 100 acts on the vehicle component 110 due to the collision of the vehicle 100, the first bracket 160 is bent, so that a stress is not concentrated on the fragile portion 162 of the first bracket 160. Therefore, even when the impact force acts on the vehicle component 110, the fragile portion 162 may not be bent. On the other hand, the coupling structure 150 according to the present embodiment includes the pressing member 180 configured to press the fragile portion 162 of the first bracket 160 when the rearward force in the longitudinal direction of the vehicle 100 acts on the vehicle component 110. Therefore, in the coupling structure 150 according to the present embodiment, when the rearward force in the longitudinal direction of the vehicle 100 acts on the vehicle component 110 due to the collision or the like of the vehicle 100, the pressing member 180 can locally apply the pressing force to the fragile portion 162 of the first bracket 160. Therefore, the coupling structure 150 according to the present embodiment can bend the fragile portion 162 of the first bracket 160 at an early stage as compared with when the pressing member 180 is not provided. Therefore, the coupling structure 150 according to the present embodiment can further relieve the impact force acting on the pedestrian and further relieve injury to the pedestrian.

The pressing member 180 according to the present embodiment presses the fragile portion 162 of the first bracket 160 when the rearward force in the longitudinal direction of the vehicle 100 acts on the vehicle component 110. Accordingly, in the normal state in which no rearward force in the longitudinal direction of the vehicle 100 acts on the vehicle component 110, the fragile portion 162 of the first bracket 160 can be avoided from being pressed by the pressing member 180. Therefore, the coupling structure 150 according to the present embodiment can ensure the strength in the normal state. Therefore, the coupling structure 150 according to the present embodiment can improve vibration durability of the vehicle component 110, improve resistance to a travel wind, improve resistance to a pressing object such as snow, and prevent the vehicle component 110 from displacing during the normal traveling of the vehicle 100.

In the coupling structure 150 according to the present embodiment, the protrusion 184 protruding rearward in the longitudinal direction of the vehicle 100 may be provided at a position facing the fragile portion 162 at the tip of the pressing member 180. When the rearward force in the longitudinal direction of the vehicle 100 due to the collision of the vehicle 100 acts on the vehicle component 110, the first bracket 160 may be curved and the fragile portion 162 of the curved first bracket 160 may be pressed by the protrusion 184 of the pressing member 180 in the state in which the first bracket 160 is sandwiched between the extending portion 172 of the second bracket 170 and the pressing member 180.

Accordingly, the coupling structure 150 according to the present embodiment can restrict bending of a portion of the first bracket 160 that is sandwiched between the extending portion 172 of the second bracket 170 and the pressing member 180. Therefore, the coupling structure 150 according to the present embodiment can sharpen the curvature of the first bracket 160, and enables the pressing member 180 to press the fragile portion 162 of the first bracket 160 at an earlier stage. In the present embodiment, the protrusion 184 protrudes rearward in the longitudinal direction of the vehicle 100 at a position facing the fragile portion 162 at the tip of the pressing member 180. Therefore, the coupling structure 150 according to the present embodiment can concentrate the pressing force on the fragile portion 162 of the first bracket 160, and can bend the fragile portion 162 of the first bracket 160 at an earlier stage.

In the coupling structure 150 according to the present embodiment, the strengths and positions of the first bracket 160 and the second bracket 170 may be adjusted such that when the rearward force in the longitudinal direction of the vehicle 100 due to the collision of the vehicle 100 acts on the vehicle component 110, first, the extending portion 172 of the second bracket 170 may be deformed to be bent rearward in the longitudinal direction of the vehicle 100, and then, the first bracket 160 may be curved to be convex rearward in the longitudinal direction of the vehicle 100, so that the fragile portion 162 of the first bracket 160 is pressed by the protrusion 184 of the pressing member 180. Accordingly, the coupling structure 150 according to the present embodiment can bend the fragile portion 162 of the first bracket 160 at an earlier stage.

The second bracket 170 according to the present embodiment may further include the attachment portion 174 attached to the structural member 120, and may have a structure in which the extending portion 172 is bent with respect to the attachment portion 174. The strength of the bent portion 176 between the attachment portion 174 and the extending portion 172 of the second bracket 170 may be smaller than that of the coupling portion 164 between the first bracket 160 and the vehicle component 110. Accordingly, the coupling structure 150 according to the present embodiment can bend the fragile portion 162 of the first bracket 160 at an earlier stage.

The fragile portion 162 of the first bracket 160 according to the present embodiment may be provided at a position where the fragile portion 162 is to be held between the protrusion 184 provided on the tip of the pressing member 180 and the tip of the extending portion 172 of the second bracket 170. Accordingly, the pressing member 180 according to the present embodiment can further concentrate the pressing force on the fragile portion 162 of the first bracket 160, and can bend the fragile portion 162 of the first bracket 160 at an earlier stage.

In the above-described embodiment, the pressing member 180 includes the protrusion 184. Alternatively, the pressing member 180 may not include the protrusion 184, for example.

In the above-described embodiment, when the rearward force in the longitudinal direction of the vehicle 100 due to the collision of the vehicle 100 acts on the vehicle component 110, the first bracket 160 is curved and the fragile portion 162 of the curved first bracket 160 is pressed by the protrusion 184 of the pressing member 180 in the state in which the first bracket 160 is sandwiched between the extending portion 172 of the second bracket 170 and the pressing member 180. Alternatively, the pressing member 180 may press the fragile portion 162 of the first bracket 160 when the rearward force in the longitudinal direction of the vehicle 100 acts on the vehicle component 110. For example, when the rearward force in the longitudinal direction of the vehicle 100 acts on the vehicle component 110, the first bracket 160 may not be curved.

In the above-described embodiment, the strength of the bent portion 176 between the attachment portion 174 and the extending portion 172 of the second bracket 170 is smaller than that of the coupling portion 164 between the first bracket 160 and the vehicle component 110. Alternatively, the strengths and positions of the first bracket 160 and the second bracket 170 may be simply adjusted such that when the rearward force in the longitudinal direction of the vehicle 100 due to the collision of the vehicle 100 acts on the vehicle component 110, first, the extending portion 172 of the second bracket 170 may be deformed to be bent rearward in the longitudinal direction of the vehicle 100, and then, the first bracket 160 may be curved to be convex rearward in the longitudinal direction of the vehicle 100, so that the fragile portion 162 of the first bracket 160 is pressed by the protrusion of the pressing member 180.

In order to relieve injury to a pedestrian when a vehicle collides with the pedestrian, Japanese Unexamined Patent Application Publication (JP-A) No. 2013-75559, for example, describes a technique of fastening a vehicle component such as a headlamp and a frame member of a vehicle body via a resin support bracket.

In a support bracket described in JP-A No. 2013- 75559, a fragile portion made of a notch is provided. Therefore, in a technique described in JP-A No. 2013- 75559, the fragile portion is bent due to an impact force on a vehicle component during a vehicle collision. Accordingly, the impact force is relieved and injury to a pedestrian is reduced.

An aspect of the disclosure provides a coupling structure configured to couple a vehicle component disposed at a front portion of a vehicle to a structural member disposed adjacently to the vehicle component in a vehicle width direction. The coupling structure includes a first bracket, a second bracket, a pressing member, and a coupling member. The first bracket is coupled to the vehicle component and extends from the vehicle component toward the structural member in the vehicle width direction. The second bracket is attached to the structural member and includes an extending portion that extends from the structural member toward the vehicle component in the vehicle width direction. The pressing member is disposed forward of the first bracket in a longitudinal direction of the vehicle. The coupling member couples the pressing member, the first bracket, and the extending portion of the second bracket to sandwich the first bracket between the pressing member and the extending portion of the second bracket. The pressing member is configured to, when a rearward force in the longitudinal direction of the vehicle acts on the vehicle component, press a fragile portion provided on a part of the first bracket.

According to an embodiment of the disclosure, it is possible to further reduce injury to a pedestrian during a vehicle collision.

Obviously, numerous modifications and variations of the present invention are possible in light of the above teachings. It is therefore to be understood that within the scope of the appended claims, the invention may be practiced otherwise than as specifically described herein.

1. A coupling structure for a vehicle, comprising:
a first bracket coupled to a vehicle component positioned at a front portion of a vehicle and extending
from the vehicle component toward a structural member positioned adjacently to the vehicle component in a vehicle width direction;
a second bracket attached to the structural member and comprising an extending portion that extends from the
structural member toward the vehicle component in the vehicle width direction;
a pressing member configured to be positioned forward of the first bracket in a longitudinal direction of the vehicle and press a fragile portion of the first
bracket when a rearward force in the longitudinal direction of the vehicle acts on the vehicle component;
and
a coupling member configured to couple the pressing member, the first bracket, and the extending portion of
the second bracket such that the first bracket is sandwiched between the pressing member and the extending portion of the second bracket.

2. The coupling structure according to claim 1,
wherein the pressing member has a protrusion configured to
face the fragile portion of the first bracket at a tip of the pressing member and protrude rearward in the longitudinal direction of the vehicle, and the first bracket and the fragile portion of the curved first
bracket are configured such that when the rearward force in the longitudinal direction of the vehicle acts on the vehicle component due to a collision of the vehicle, the first bracket is curved and the fragile portion is pressed by the protrusion of the pressing member in a state in which the first bracket is sandwiched between the extending portion of the second bracket and the pressing member.

3. The coupling structure according to claim 2,
wherein the first bracket and the second bracket are configured to be adjusted in strength and positions such that when the rearward force in the longitudinal direction of the vehicle acts on the vehicle component due to the collision of the vehicle, the extending portion of the
second bracket is bent reward in the longitudinal direction of the vehicle, the first bracket is subsequently curved to be convex rearward in the longitudinal direction of the vehicle, and the fragile portion of the first bracket is pressed by the protrusion of the pressing member.

4. The coupling structure according to claim 1,
wherein the second bracket further comprises an attachment portion attached to the structural member and has a
structure in which the extending portion is bent with respect to the attachment portion such that a strength of a bent portion between the attachment portion and the extending portion of the second bracket is smaller than a strength of a coupling portion between the first bracket and the vehicle component.

5. The coupling structure according to claim 2
wherein the second bracket further comprises an attachment portion attached to the structural member and has a
structure in which the extending portion is bent with respect to the attachment portion such that a strength of a bent portion between the attachment portion and the extending portion of the second bracket is smaller than a strength of a coupling portion between the first bracket and the vehicle component.

6. The coupling structure according to claim 3,
wherein the second bracket further comprises an attachment portion attached to the structural member and has a
structure in which the extending portion is bent with 27
respect to the attachment portion such that a strength of a bent portion between the attachment portion and the extending portion of the second bracket is smaller than a strength of a coupling portion between the first bracket
and the vehicle component.

7. The coupling structure according to claim 1,
wherein the fragile portion of the first bracket is positioned to allow the fragile portion to be held between
a protrusion provided on a tip of the pressing member and a tip of the extending portion of the second bracket.

8. The coupling structure according to claim 2,
wherein the fragile portion of the first bracket is
positioned to allow the fragile portion to be held between a protrusion provided on a tip of the pressing member and a tip of the extending portion of the second bracket.

9. The coupling structure according to claim 3, wherein the fragile portion of the first bracket is positioned to allow the fragile portion to be held between a protrusion provided on a tip of the pressing member and a tip of the extending portion of the second bracket.
